(19) United States
(12) Patent Application Publication
(10) Pub. No.: US 2015/0095750 A1
(43) Pub. Date: Apr. 2, 2015

(54) MESSAGE EDITING METHOD, MESSAGE EDTING APPARATUS, AND MESSAGE COMMUNICATION SYSTEM

(71) Applicant: MEDIASEEK, inc., Tokyo (JP)

(72) Inventors: Naoki Nishio, Tokyo (JP); Yasuhiro Nezu, Tokyo (JP); Akira Tateishi, Tokyo (JP)

(21) Appl. No.: 14/562,853

(22) Filed: Dec. 8, 2014

Related U.S. Application Data
(63) Continuation of application No. PCT/JP2012/068437, filed on Jul. 20, 2012.

(51) Int. Cl. G06F 17/24; G06T 11/60

(52) U.S. Cl. CPC G06F 17/24; G06T 11/60
USPC 715/202

(57) ABSTRACT

A message editing apparatus includes a receiving part which receives text data from a message communication terminal connected through a communication line, a storage part which stores the text data and additional data corresponding to the text data, a display time determining part which determines display time of the additional data, a dividing part which divides the text data into a plurality of divided text portions according to the display time, a message generating part which generates a synthesized message containing the additional data and the plurality of divided text portions, and a transmitting part which transmits the synthesized message to a destination specified by the message communication terminal.

### CROSS-REFERENCE TO RELATED APPLICATIONS

The present application is a continuation application of International Application number PCT/JP2012/68437, filed on Jul. 20, 2012. The content of this application is incorporated herein by reference in its entirety.

### BACKGROUND OF THE INVENTION

The present disclosure relates to a message editing method, a message editing apparatus, and a message communication system including the message editing apparatus for editing a message generated by synthesizing text data made by a user and additional data such as image, video, and voice.

Conventionally, a message transmitting apparatus which can transmit messages expressing feelings by attaching additional data such as image, video, and voice to the text data according to the content of the text data is known (for example, see Japanese Unexamined Patent Application Publications No. 2004-088335 and No. 2004-139602).

However, the conventional message transmitting apparatus transmits the message that is generated by synthesizing the text data and the additional data, and a receiver who receives the message can only see the text data and the additional data at the same time. The message generated by the conventional message transmitting apparatus can convey the feelings of a sender to the receiver by using an appropriate expression in the text data and the image of the additional data, but the conventional message transmitting apparatus was not able to transmit the message at suitable timings for situations like a conversation.

Further, with the conventional message transmitting apparatus, the receiver who receives the message can read the content of the message at an uncontrolled speed. Accordingly, although the sender wants the receiver to take a long time to read the message, the receiver sometimes reads the message in a short time. As a result, there is a problem that the feeling of the sender is not fully understood by the receiver.

### BRIEF SUMMARY OF THE INVENTION

Therefore, in one aspect of the innovation included herein, a message editing method, a message editing apparatus, and a message communication system that can make and transmit a message which is displayed at the timing suitable for the text data made by a user are provided.

In the first aspect of the present disclosure, a message editing method comprises receiving text data from a message communication terminal connected through a communication line, determining a display time of additional data corresponding to the text data, dividing the text data into a plurality of divided text portions according to the display time, generating a synthesized message containing the additional data and the plurality of divided text portions, and transmitting the synthesized message to a destination specified by the message communication terminal is provided.

In the second aspect of the present disclosure, a message editing apparatus comprises a receiving part configured to receive text data from a message communication terminal connected through a communication line, a storage part configured to store the text data and additional data corresponding to the text data, a display time determining part configured to determine a display time of the additional data, a dividing part configured to divide the text data into a plurality of divided text portions according to the display time, a message generating part configured to generate a synthesized message containing the additional data and the plurality of divided text portions, and a transmitting part configured to transmit the synthesized message to a destination specified by the message communication terminal is provided.

In the third aspect of the present disclosure, a message communication system comprises a first message communication terminal configured to transmit text data, a second message communication terminal configured to receive the text data, and a message editing apparatus configured to transmit and receive a message containing the text data between the first message communication terminal and the second message communication terminal is provided. The first message communication terminal provides a message communication system which includes an inputting part configured to receive an input of the text data, a selecting part configured to receive a selection of additional data to be transmitted with the text data, a display time determining part configured to determine a display time of the text data and the additional data, and a data transmitting part configured to transmit the text data, the additional data, and the display time to the message editing apparatus.

### BRIEF DESCRIPTION OF THE DRAWINGS

FIG. 1 shows a configuration of a message communication system according to the first exemplary embodiment.

FIG. 2 shows the configuration example of a message editing apparatus according to the first exemplary embodiment.

FIG. 3 shows an example of a flow chart of a message editing operation according to the first exemplary embodiment.

FIG. 4 shows a display example of a synthesized message generated in the message communication system according to the first exemplary embodiment.

FIG. 5 shows an example of a message transmitting and receiving sequence according to the first exemplary embodiment.

FIG. 6 shows another configuration example of the message editing apparatus according to the first exemplary embodiment.

FIG. 7 shows a configuration example of a message communication terminal according to the second exemplary embodiment.

### DETAILED DESCRIPTION OF THE INVENTION

Hereinafter, the present disclosure is described through embodiments of the present disclosure. The following embodiments do not limit the claimed inventions, and all of the combinations of the features that are described in the embodiments are not always essential for the means for solving the problems of the disclosure.

### The First Exemplary Embodiment

### [A Basic Configuration of a Message Communication System 10]

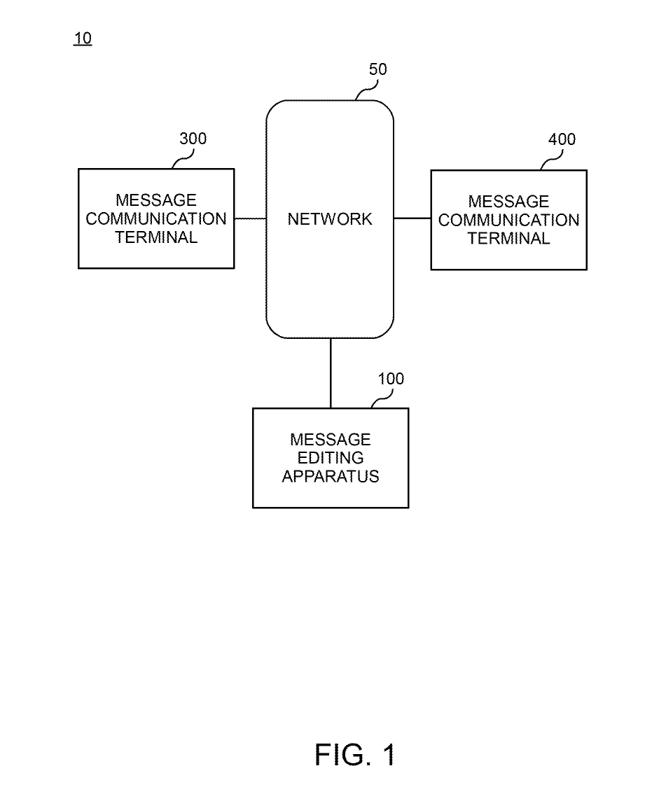

FIG. 1 shows a configuration example of a message communication system 10 according to the present embodiment. The message communication system 10 includes a message editing apparatus 100, a message communication terminal 300, and a message communication terminal 400. The message editing apparatus 100, the message communication terminal 300, and the message communication terminal 400 transmit and receive data with each other through a network 50. The network 50 is, for example, the Internet or a local area network. The message editing apparatus 100 is, for example, a server, and the message communication terminal 300 and the message communication terminal 400 are, for example, a smart phone or a computer.

The message communication terminal 300 and the message communication terminal 400 can transmit and receive a message via the message editing apparatus 100. For example, the message communication terminal 300 can transmit a message containing text data inputted by a user with additional data such as image, video, music, and voice to the message communication terminal 400. The message editing apparatus 100 edits the message received from the message communication terminal 300 and transmits the message to the message communication terminal 400.

### [The Basic Configuration of the Message Editing Apparatus 100]

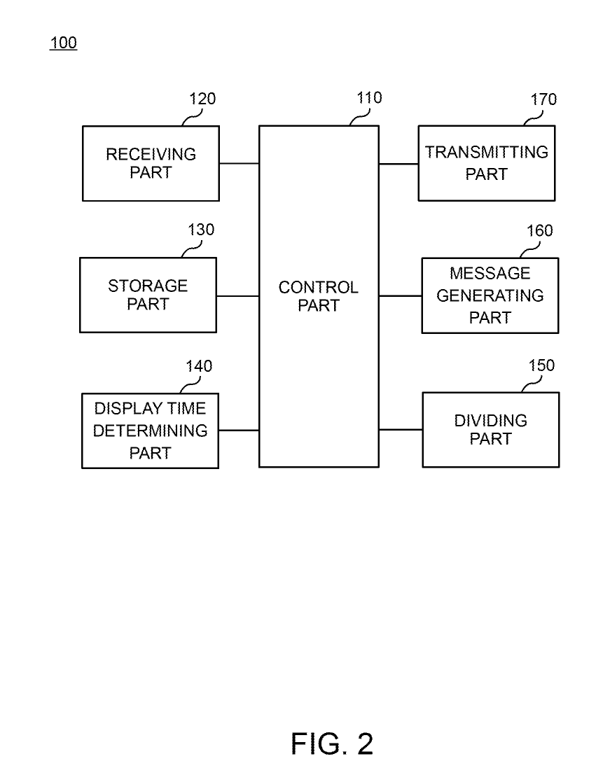

FIG. 2 shows the configuration example of the message editing apparatus 100 according to the present embodiment. The message editing apparatus 100 includes a control part 110, a receiving part 120, a storage part 130, a display time determining part 140, a dividing part 150, a message generating part 160, and a transmitting part 170. The control part 110 is, for example, a microprocessor which operates the message editing apparatus 100. The control part 110 controls the receiving part 120, the storage part 130, the display time determining part 140, the dividing part 150, the message generating part 160, and the transmitting part 170.

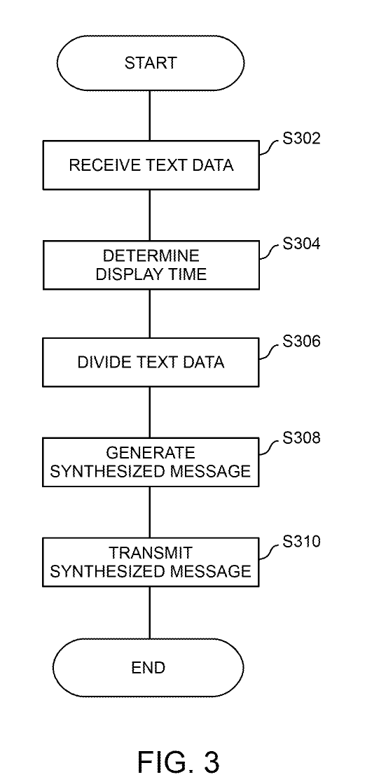

FIG. 3 shows an example of a flow chart of a message editing operation according to the present embodiment. Hereinafter, the operation of the message editing apparatus 100 is described by referring to FIG. 2 and FIG. 3. The control part 110 performs the following operations by executing a program stored in the storage part 130.

The receiving part 120 receives the text data from the message communication terminal 300 connected through a communication line (S302). The receiving part 120 may receive the additional data corresponding to the text data from the message communication terminal 300. The receiving part 120 may receive display time information showing the length of time for displaying the text data and the additional data from the message communication terminal 300. The receiving part 120 may receive the text data which contains a destination of the message containing the text data and the additional data.

The storage part 130 stores the text data and the additional data corresponding to the text data. The storage part 130 may store a plurality of pieces of additional data in advance, and may store the additional data received from the message communication terminal 300. The storage part 130 may be a nonvolatile memory or a volatile memory. The storage part 130 may be a recording medium such as a removable memory card or a CD-ROM.

The display time determining part 140 determines the display time of the additional data which is used for the message to be generated (S304). The display time of the additional data is the length of time for displaying the additional data. For example, the display time determining part 140 determines a period of time for displaying the additional data in the message communication terminal 400 on the basis of the display time information received from the message communication terminal 300. The display time determining part 140 may determine the display time of the message on the basis of a standard display time stored in the storage part 130 in association with the additional data specified by the message communication terminal 300.

The display time determining part 140 may determine the display time according to the content of the additional data corresponding to the text data. For example, when the additional data is music data, the display time determining part 140 determines the display time to be the length of music contained in the music data. When the additional data contains a plurality of contents, the display time determining part 140 may determine the display time to be the sum of the times for displaying each of the contents. The display time determining part 140 may determine the display time to be the standard display time stored in the storage part 130 in association with the additional data.

The display time determining part 140 may determine the display time of the additional data on the basis of the number of characters being displayed in a unit of time (hereinafter referred to as “display speed”) and the number of characters of the text data. The display time determining part 140 may receive a designated display speed from the message communication terminal 300, or may determine the display speed according to a keyword contained in the text data.

For example, the display time determining part 140 determines the display time by dividing the number of characters of the text data by the display speed selected from among (i) the first display speed which is 3 characters per second, (ii) the second display speed which is 5 characters per second, and (iii) the third display speed which is 7 characters per second. For example, when the second display speed is selected, the display time determining part 140 determines the time for displaying the text data of 150 characters to be 30 seconds. The display time determining part 140 may add waiting times corresponding to specific characters or codes such as period (.), a comma (,), a line break, and a space character, to the display time determined on the basis of the display speed and the number of characters. The display time determining part 140 may add different waiting times according to the display speed.

The dividing part 150 divides the text data received by the receiving part 120 into a plurality of divided text portions according to the display time determined by the display time determining part 140 (S306). The dividing part 150 may divide the text data into a number of divided text portions on the basis of the display time and length of the text data. For example, when the display time determined by the display time determining part 140 is 30 seconds, and about 20 seconds are required for reading the text data, the dividing part 150 divides the text data into three divided text portions for changing the divided text portions in turn about every 10 seconds, so that the text data becomes easier to read. Further, if the number of characters of the text data received by the receiving part 120 is not so large that the number of characters must be divided, the dividing part 150 need not divide the text data into the divided text portions.

The dividing part 150 may divide the text data at such positions that enable a reader of the message to easily read the message. For example, the dividing part 150 divides the text right after line breaks, space characters, periods, or commas in the text data. The dividing part 150 may divide the text at positions in front of words, such as “by the way,” “but,” “however,” and “I would like to change the subject,” which are used for changing a topic to another one.

The message generating part 160 generates a synthesized message containing the additional data and the plurality of divided text portions divided by the dividing part 150 (S308). Specifically, the message generating part 160 generates the synthesized message whose divided text portions are sequentially changed while the additional data is displayed. For example, the message generating part 160 generates the synthesized message including video content with the length of 30 seconds, the first divided text portion displayed during the time from 0 seconds to 10 seconds, the second divided text portion displayed during the time from 10 seconds to 20 seconds, and the third divided text portion displayed during the time from 20 seconds to 30 seconds.

The transmitting part 170 transmits the synthesized message generated by the message generating part 160 to the destination specified by the message communication terminal 300 (S310). The transmitting part 170 may transmit the synthesized message generated by the message generating part 160 to the destination (for example, the message communication terminal 400) contained in the text data received by the receiving part 120. Further, the transmitting part 170 may transmit the synthesized message generated by the message generating part 160 to the destination contained in a part of the additional data.

When the message generating part 160 generates the synthesized message, the transmitting part 170 may transmit icon image data showing that there is a message to the message communication terminal 400. When the displayed icon image is selected by the user, the message communication terminal 400 transmits a message request to the message editing apparatus 100. When the transmitting part 170 receives the message request, the transmitting part 170 transmits the synthesized message to the message communication terminal 400.

As described above, according to the message communication system 10 of the present embodiment, the user of the message communication terminal 300 can transmit, to the user of the message communication terminal 400, the synthesized message whose text data is changed at timings good for reading the text data in accordance with the display time of the additional data such as the image and the video.

### [A Display Example of the Synthesized Message]

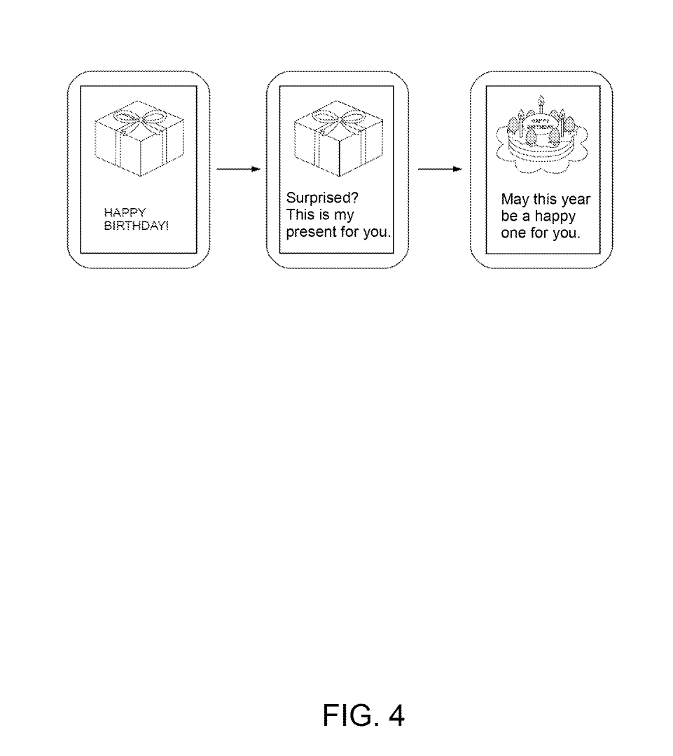

FIG. 4 shows a display example of the synthesized message generated in the message communication system 10 according to the present embodiment. In FIG. 4, the images displayed on the upper side of the screen of the message communication terminal 400 and the divided text portions corresponding to the images are shown. For example, the message communication terminal 400 changes the image and the divided text portion to be displayed every 5 seconds and displays the text data and the image for 15 seconds. The message communication terminal 400 may further play the music.

The message communication terminal 400 may change the divided text portion to be displayed by putting an image, which masks at least a part of the plurality of divided text portions and pieces of additional data, on the divided text portions and the additional data. For example, the message communication terminal 400 can control the divided text portion to be gradually displayed as time passes by changing transparency of the mask image put on the divided text portion.

### [Extracting a Part of the Music According to the Display Time]

The message generating part 160 may generate the synthesized message by extracting a part of the additional data on the basis of the display time determined by the display time determining part 140. Specifically, when the additional data corresponding to the text data is music data, and the length of the playing time of the music is longer than the length of the display time determined by the display time determining part 140, the message generating part 160 may extract the data corresponding to a period of time whose length is the same as the display time from the additional data stored in the storage part 130. For example, the message generating part 160 generates the synthesized message by extracting the most important part of the music data (for example, the catchy part of the music) in accordance with the display time.

The storage part 130 may store a center position of the most important part of each piece of music. For example, the storage part 130 stores the position where the volume of the music becomes the largest as the center position. The message generating part 160 may extract a part of the music data corresponding to the display time around the center position from the music data. The message generating part 160 may extract a part of the additional data with the length corresponding to the display time at around the center position of a part of the additional data, corresponding to the text data, which was extracted to be used in the past. The message generating part 160 may extract a part of the music data corresponding to the display time whose center position is the average of center positions of the parts of the same pieces of music extracted in the past. The message generating part 160 may determine the center position to be the position where the volume becomes the largest in the part of the additional data extracted in the past.

As described above, the message generating part 160 extracts a part of the additional data in accordance with the display time and generates the synthesized message, and so the additional data whose length is suitable for the display time determined by the display time determining part 140 can be synthesized.

### [Controlling the Display Timing Using Metadata]

The message editing apparatus 100 can generate the synthesized message which is displayed at timings suitable for the content of the message by using metadata in which the display timing of the text data and the additional data is described. Specifically, the message generating part 160 generates the synthesized message containing the metadata in which time information showing the timings of displaying each of the divided text portions divided by the dividing part 150 is described. For example, the message generating part 160 generates the metadata containing at least one of the display start time and the display end time of the divided text portions in association with identification information unique to each of the divided text portions.

The metadata may contain total display time of the synthesized message TT, the first blank time PreL, the last blank time EpiL, the divided text portion changing time CT, and the number of the divided text portions N. For example, suppose that TT is 45 seconds, PreL is 2 seconds, EpiL is 2 seconds, CT is 1 second, and N is 7. In this case, the message communication terminal 400 which received the metadata may calculate the display time of one divided text portion to be [TT−PreL−EpiL−(N−1)×CT]÷N=5 seconds.

If the additional data is video data or voice data containing the time information, the message generating part 160 may generate the metadata in which at least one of the display start time and the display end time of the divided text portions is described in association with the time information included in the additional data. When the additional data does not include the time information, the message generating part 160 may generate the metadata showing the display start time and the display end time of each of the divided text portions and the additional data by making the display start time of the first divided text portion to be a starting point. The message generating part 160 may generate the metadata containing a display order of each of the divided text portions and the display times of each of the divided text portions.

The message communication terminal 400 which received the synthesized message refers to the metadata contained in the synthesized message, and displays the divided text portions and the additional data on the basis of the time information contained in the metadata.

As described above, the message communication system 10 controls the display time of each of the divided text portions and the additional data by using the metadata, and so the message communication system 10 can transmit the synthesized message which is displayed at the timing suitable for the content of the message.

### [Controlling the Display Timing Using a Communication Protocol]

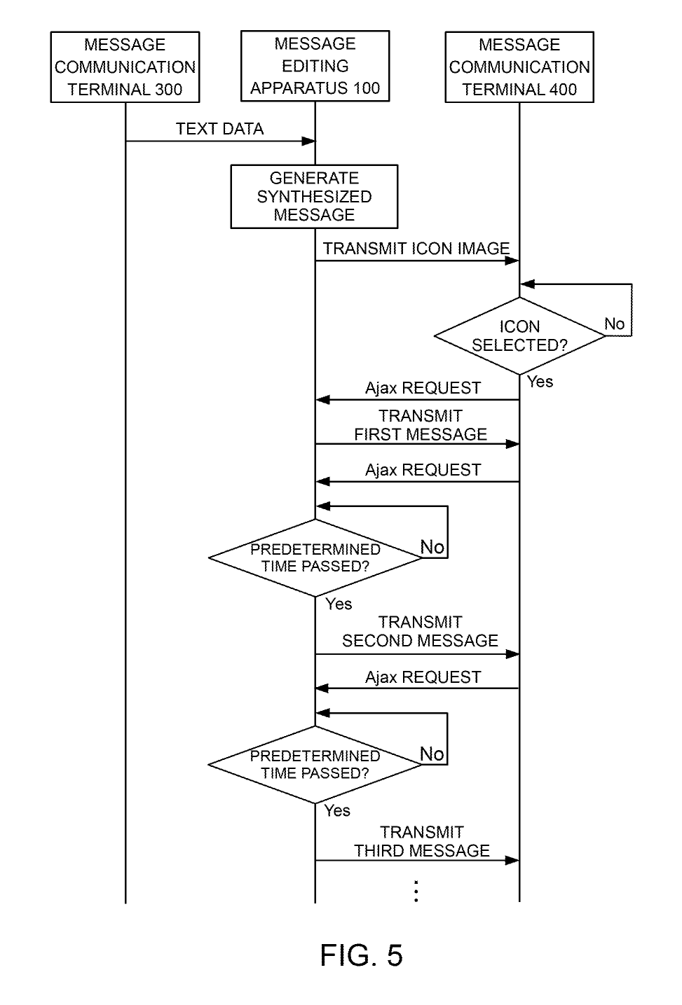

FIG. 5 shows an example of a message transmitting and receiving sequence according to the first exemplary embodiment. The message editing apparatus 100 may control the timing of displaying the synthesized message by using a communication protocol instead of using the metadata. For example, the message editing apparatus 100 transmits the icon image showing that the message reached the message communication terminal 400 on the receiving side. When the user selects the icon image, the message communication terminal 400 transmits, for example, an Ajax request message to the message editing apparatus 100.

The message editing apparatus 100 is implemented with the Comet application, and when the message editing apparatus 100 receives the Ajax request message from the message communication terminal 400, the message editing apparatus 100 stands still in a state where the HTTP session is open and can transmit the message to the message communication terminal 400 at any timing. Specifically, when the message editing apparatus 100 receives the Ajax request message, the message editing apparatus 100 transmits the first message containing the divided text portion 1 and the additional data 1 to the message communication terminal 400. When the message communication terminal 400 receives the first message, the message communication terminal 400 transmits the Ajax request message and also displays the divided text portion 1 and the additional data 1.

The message editing apparatus 100 transmits the second message containing the divided text portion 2 and the additional data 2 to the message communication terminal 400, provided that the Ajax request message is received and that the timing has come when the divided text portion 2 and the additional data 2 are to be transmitted. The message editing apparatus 100 and the message communication terminal 400 can display the divided text portions and the additional data at suitable display timings in the message communication terminal 400 by executing the above processes until transmitting and receiving of all of the divided text portions and the additional data are finished.

After the message editing apparatus 100 transmits the synthesized message containing the plurality of divided text portions and respective identification numbers of the divided text portions to the message communication terminal 400, the message editing apparatus 100 may transmit the identification number of the divided text portion to be displayed at the timings of displaying each of the divided text portions. The message communication terminal 400 may sequentially display the divided text portions corresponding to the received identification numbers.

[Generating the Message with the Condition of a Period or a Place for Displaying the Message]

The message generating part 160 may generate display condition information showing a condition that the synthesized message can be displayed. The transmitting part 170 may transit the display condition information to the destination to which the synthesized message is transmitted. For instance, the message generating part 160 generates the synthesized message which can be read only during a time period specified by a sender, and also generates the display condition information in which the time period when the message can be read is described.

For example, when the sender transmits the synthesized message with the content “happy birthday,” the sender wants the receiver to read the message on their birthday. Hence, the message generating part 160 may generate the synthesized message with the information showing the date and time when the message is permitted to be opened.

The transmitting part 170 may transmit the icon image containing the display condition information showing the date and time when the message is permitted to be opened before transmitting the synthesized message to the message communication terminal 400. The message communication terminal 400 displays the received icon image. The message communication terminal 400 requests the synthesized message from the message editing apparatus 100 if the date and time when the icon image is selected by a user is after the date and time when the message is permitted to be opened. If the date and time when the icon image is selected by the user is prior to the date and time when the message is permitted to be opened, the message communication terminal 400 may display an error message.

When the transmitting part 170 receives the request for the synthesized message from the message communication terminal 400, the transmitting part 170 transmits the synthesized message. When the message editing apparatus 100 transmits the synthesized message with the above procedures, the receiver of the message can read the synthesized message after the date and time specified by the sender.

The message generating part 160 may generate the synthesized message which can be read only at a place specified by the sender. For example, if the place where the message for notifying “a player to take the mound at a baseball game” can be displayed should be limited to “a baseball field,” the message generating part 160 generates the synthesized message with position information of the place where the synthesized message can be displayed.

When the message communication terminal 400 receives the synthesized message with the position information attached, and the user of the message communication terminal 400 performs an operation to open the synthesized message, the message communication terminal 400 acquires the position information by using, for example, the global positioning system (GPS). The message communication terminal 400 displays the synthesized message when the position information attached to the synthesized message matches the position information acquired by the GPS.

As described above, by setting the condition for limiting when and where the synthesized message can be displayed, the user who sends the message can make the message communication terminal 400 of a person who receives the message display the message at the time or the place that the user who sends the message likes.

### [Selecting the Additional Data on the Basis of a Keyword in the Text]

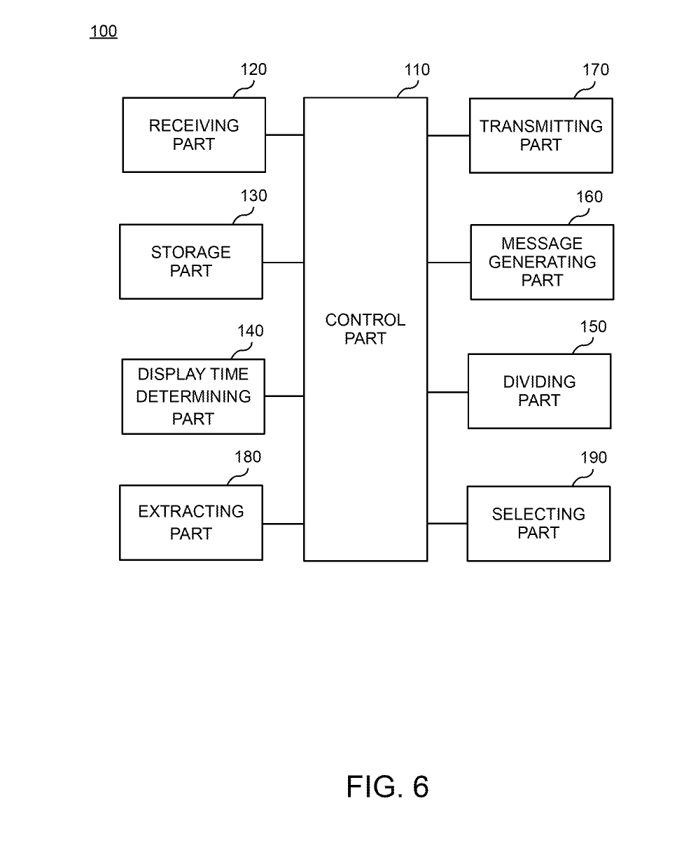

FIG. 6 shows another configuration example of the message editing apparatus 100 according to the present embodiment. The message editing apparatus 100 shown in FIG. 6 is different from the message editing apparatus 100 shown in FIG. 2 in a point that the message editing apparatus 100 shown in FIG. 6 further includes an extracting part 180 and a selecting part 190.

The storage part 130 may store the plurality of pieces of additional data in association with a plurality of keywords. The extracting part 180 extracts the keyword stored in the storage part 130 from the text data received by the receiving part 120. The selecting part 190 selects the additional data corresponding to the keyword extracted by the extracting part 180 from among the plurality of pieces of additional data stored in the storage part 130. For example, when the receiving part 120 receives the text data “congratulations on your wedding,” the extracting part 180 extracts the keyword “wedding” stored in the storage part 130 in advance. Next, the selecting part 190 selects the additional data associated with the keyword “wedding,” for example, the music data of “Mendelssohn's Wedding March.”

The selecting part 190 may transmit, to the message communication terminal 300, a plurality of candidate names of the additional data corresponding to the keyword extracted by the extracting part 180 from the text data received by the receiving part 120, and may select the additional data selected in the message communication terminal 300 as the additional data for generating the synthesized message. The selecting part 190 may transmit the candidate names of the additional data along with the information showing the standard display time for each piece of the additional data to the message communication terminal 300. The selecting part 190 may calculate the display time suitable for the length of the text data, and may transmit, to the message communication terminal 300, the priority order of the plurality of pieces of additional data determined on the basis of the calculated display time and the keyword contained in the text data, together with the candidate names of the additional data.

As described above, the message editing apparatus can reduce the time and effort of the user of the message communication terminal 300 needed to select the additional data by storing the additional data in association with the keyword in the storage part 130 in advance. Particularly, the selecting part 190 automatically selects the additional data, and so the user can transmit the synthesized message suitable for the content of the text data simply by making the text data.

### [Determining Display Speed on the Basis of the Keyword in the Text]

The message editing apparatus 100 may generate the synthesized message which is displayed at a speed corresponding to the content of the text data made by the user. Specifically, the storage part 130 may store display speeds of the text data containing each of the keywords in association with the plurality of keywords. The display time determining part 140 may read, from the storage part 130, the display speed corresponding to the keyword extracted by the extracting part 180 from the text data received by the receiving part 120, and may determine the display time of the additional data on the basis of the read display speed.

More specifically, the storage part 130 stores the first display speed which is relatively slow in association with the keywords contained in such messages that express sorrow and that the sender of the message wants the receiver to read slowly. On the other hand, the storage part 130 stores the second display speed which is relatively fast in association with the keywords contained in such messages that contain urgent matters and that the sender of the message wants the receiver to read quickly.

For example, the storage part 130 stores the first display speed of “3 characters/sec” in association with the keyword “condolence,” and stores the second display speed of “5 characters/sec” which is faster than the first display speed in association with the keyword “go for it.” When the extracting part 180 extracts the keyword “condolence” from the text data containing 60 characters, the display time determining part 140 determines the display time to be 20 seconds by dividing the number of characters of the text data by the display speed stored in association with the keyword contained in the text data.

As described above, the storage part 130 stores the display speed in association with the keyword, and the display time determining part 140 determines the display time on the basis of the display speed corresponding to the keyword, and so the message editing apparatus 100 can generate the synthesized message which is displayed at the speed suitable for the content of the message.

### [Changing an Arrangement on the Basis of the Keyword in the Text]

The message generating part 160 may arrange the additional data according to the keyword contained in the text data received by the receiving part 120. Further, the message generating part 160 may generate the synthesized message containing the arranged additional data.

For example, when the text data received by the receiving part 120 contains a keyword expressing sorrow and the additional data is the music data, the message generating part 160 may add an arrangement to the music data to change its key from major to minor. When the text data contains a keyword expressing joy, the message generating part 160 may accelerate the tempo or turn up the volume of the music data.

As described above, the message generating part 160 adds the arrangement to the additional data such as music and images according to the content of the text data received by the receiving part 120, and so a person who receives the synthesized message can read the message in a mood suitable for the content of the text data.

### [Making the User Select the Additional Data on the Basis of History Information of the Additional Data]

The storage part 130 may store the information showing the history of additional data selection made by the user. For example, the storage part 130 stores a name of the additional data which has been frequently used in association with the keyword as history information. The storage part 130 may store the number of times each piece of the additional data was selected during a predetermined period of time. The transmitting part 170 transmits a plurality of additional data candidates corresponding to the text data to the message communication terminal 300, which is the sender of the text data, on the basis of the history information stored in the storage part 130. In this case, the transmitting part 170 may also transmit the history information to the message communication terminal 300.

The message communication terminal 300 displays the received plurality of additional data candidates. When the message communication terminal 300 receives the history information, the message communication terminal 300 also displays the received history information. When the user of the message communication terminal 300 selects one additional data candidate from among the plurality of additional data candidates, the message communication terminal 300 transmits the selected additional data candidate to the message editing apparatus 100.

When the receiving part 120 receives the additional data candidate, the selecting part 190 selects the additional data corresponding to the additional data candidate received from the message communication terminal 300. The message generating part 160 synthesizes the selected additional data with the text data to generate the synthesized message.

The storage part 130 may store not only the history information showing additional data usage by the user of the message communication terminal 300 but also the history information showing additional data usage by other users. The selecting part 190 may automatically select the additional data whose frequency of usage stored in the storage part 130 is high. For example, the selecting part 190 selects the additional data with high frequency of usage from among the additional data corresponding to the keyword extracted by the extracting part 180, and the message generating part 160 generates the synthesized message containing the selected additional data.

As described above, by selecting the additional data on the basis of the history information stored in the storage part 130, the message editing apparatus 100 can generate the synthesized message using the frequently used additional data. Particularly, by selecting the frequently used additional data corresponding to the keyword contained in the text data, the message editing apparatus 100 can reduce the time and effort needed for the user who sends the message, and generate the synthesized message suitable for the text data.

### The Second Exemplary Embodiment

### [Generating the Synthesized Message in the Message Communication Terminal 300]

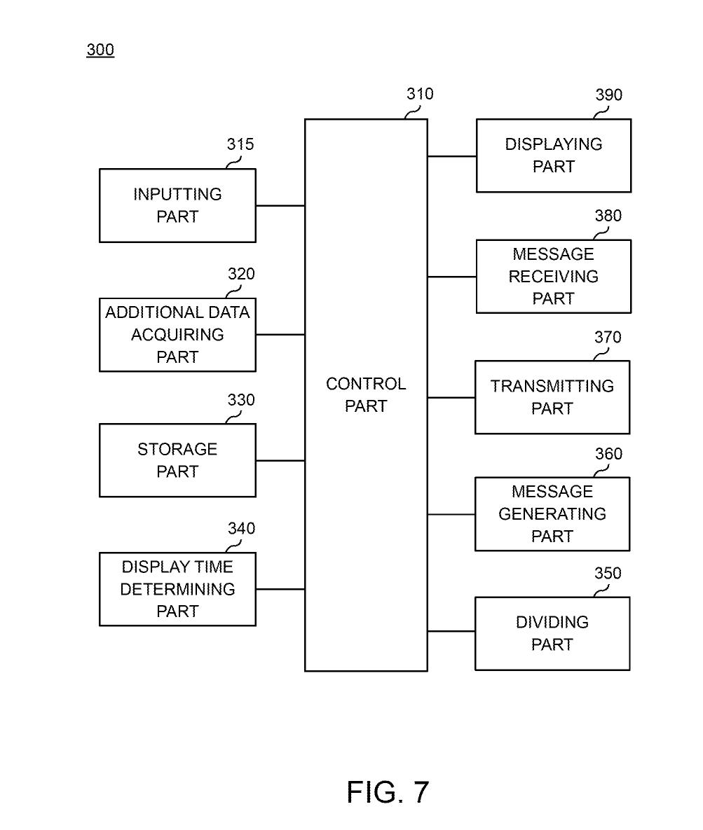

FIG. 7 shows a configuration example of the message communication terminal 300 according to the second exemplary embodiment. The message communication terminal 400 may include the same configuration. The message communication terminal 300 includes a control part 310, an inputting part 315, an additional data acquiring part 320, a storage part 330, a display time determining part 340, a dividing part 350, a message generating part 360, a transmitting part 370, a message receiving part 380, and a displaying part 390.

The storage part 330, the display time determining part 340, the dividing part 350, the message generating part 360, and the transmitting part 370 respectively have the functions similar to the storage part 130, the display time determining part 140, the dividing part 150, the message generating part 160, and the transmitting part 170 in the message editing apparatus 100 described in the first exemplary embodiment.

The control part 310 is, for example, a microprocessor operating the message communication terminal 300 by executing a program stored in the storage part 330. The control part 310 controls the inputting part 315, the additional data acquiring part 320, the storage part 330, the display time determining part 340, the dividing part 350, the message generating part 360, the transmitting part 370, the message receiving part 380, and the displaying part 390.

The inputting part 315 receives input of the text data from the user of the message communication terminal 300. The inputting part 315 may receive the text data inputted by the user of the message communication terminal 300 via another terminal.

The additional data acquiring part 320 acquires the additional data to be transmitted with the text data by an operation of the user of the message communication terminal 300. For example, the additional data acquiring part 320 downloads the additional data from a server connected through the network 50 by the operation of the user. The additional data acquiring part 320 may acquire the additional data corresponding to the text data inputted by the user from among the plurality of pieces of additional data stored in the storage part 330 in advance.

The storage part 330 stores the text data inputted to the inputting part 315 by the user of the message communication terminal 300 and the additional data acquired by the additional data acquiring part 320. The display time determining part 340 acquires the display time information showing the display time of the text data and the additional data. The display time determining part 340 may acquire the display time information inputted by the user, and may acquire the display time information stored in the storage part 330 in association with the additional data. The control part 310 calculates the display time on the basis of the number of characters of the text data, and the display time determining part 340 may acquire the display time information corresponding to the display time calculated by the control part 310.

The dividing part 350 divides the text data inputted by the user of the message communication terminal 300 into a plurality of divided text portions according to the display time acquired by the display time determining part 340.

The message generating part 360 generates the synthesized message containing the additional data acquired by the additional data acquiring part 320 and the plurality of divided text portions divided by the dividing part 350. The message generating part 360 may generate the synthesized message by a method similar to the method used by the message generating part 160 according to the first exemplary embodiment. The transmitting part 370 transmits the synthesized message generated by the message generating part 360 to the destination specified by the message communication terminal 300.

For example, the synthesized message sent by the transmitting part 370 is transmitted to the message communication terminal 400 through the network 50 shown in FIG. 1. In the message communication terminal 400, the message receiving part 380 receives the synthesized message. The displaying part 390 displays the additional data and sequentially displays the plurality of divided text portions during the display time specified by the synthesized message.

As described above, the message communication terminal 300 of the present embodiment can generate and transmit the synthesized message which is displayed for the display time suitable for its text data and additional data in response to the operation of the user. The message communication terminal 400 which receives the synthesized message can display the text data and the additional data for the above display time.

The present disclosure is described with the exemplary embodiments but the technical scope of the present disclosure is not limited to the scope described in the above embodiment. It is apparent for those skilled in the art that it is possible to make various changes and modifications to the embodiment. It is apparent from the description of the scope of the claims that the forms added with such changes and modifications are included in the technical scope of the present disclosure.

It should be noted that execution order of each process of means shown in claims, specification, and drawings is not clearly indicated with the words such as “before” and “in advance,” and unless an output of a previous process is used in a later process, the process may be performed in any order. Regarding an operation flow in the claims and specification, even when described using “first,” “next” or the like, it does not mean that it is essential to be performed in the order.

What is claimed is:

1. A message editing method comprising:
receiving text data from a message communication terminal connected through a communication line;
determining a display time of additional data corresponding to the text data;
dividing the text data into a plurality of divided text portions according to the display time;
generating a synthesized message containing the additional data and the plurality of divided text portions; and
transmitting the synthesized message to a destination specified by the message communication terminal.

2. The message editing method according to claim 1, wherein
the generating of the synthesized message includes generating the synthesized message by extracting a part of the additional data on the basis of the display time.

3. The message editing method according to claim 1, wherein
the generating of the synthesized message includes generating the synthesized message containing metadata in which time information showing timings for displaying each of the plurality of divided text portions is described.

4. The message editing method according to claim 1, wherein
the generating of the synthesized message includes generating display condition information showing a condition that the synthesized message can be displayed, and
the transmitting includes transmitting the display condition information to the destination.

5. The message editing method according to claim 1, wherein
the determining of the display time includes determining the display time of the additional data on the basis of the number of characters of the text data.

6. The message editing method according to claim 1, further comprising:
extracting a plurality of keywords stored in advance in a memory from the text data; and
selecting the additional data corresponding to the extracted keywords.

7. The message editing method according to claim 6, wherein
the determining of the display time includes determining the display time of the additional data corresponding to the text data containing a keyword on the basis of display speed of the text data containing the plurality of keywords stored in the storage part.

8. The message editing method according to claim 6, wherein
the generating of the synthesized message includes arranging the additional data according to a keyword contained in the text data.

9. The message editing method according to claim 1, wherein
the generating of the synthesized message includes:
extracting a part of the additional data with the length corresponding to the display time at around the center position of a part of the additional data which was extracted to be used in the past, the additional data corresponding to the text data, and
generating the synthesized message containing the extracted additional data and the plurality of divided text portions.

10. The message editing method according to claim 9, wherein
the extracting of the part of the additional data with the length corresponding to the display time includes determining the center position to be the position where the volume becomes the largest in the part of the additional data extracted to be used in the past.

11. The message editing method according to claim 1, wherein
the generating of the synthesized message includes generating the synthesized message with attached information showing a date and time when the synthesized message is permitted to be opened.

12. The message editing method according to claim 1, wherein
the generating of the synthesized message includes generating the synthesized message with attached position information indicating a place where the synthesized message is permitted to be opened.

13. The message editing method according to claim 1, wherein
the generating of the synthesized message includes selecting the additional data on the basis of a history of additional data selection for the text data.

14. The message editing method according to claim 1, further comprising:
transmitting a plurality of additional data candidates corresponding to the text data and the information showing the history of additional data selection to the message communication terminal.

15. A message editing apparatus comprising:
a receiving part configured to receive text data from a message communication terminal connected through a communication line;
a storage part configured to store the text data and additional data corresponding to the text data;
a display time determining part configured to determine a display time of the additional data;
a dividing part configured to divide the text data into a plurality of divided text portions according to the display time;
a message generating part configured to generate a synthesized message containing the additional data and the plurality of divided text portions; and
a transmitting part configured to transmit the synthesized message to a destination specified by the message communication terminal.

16. The message editing apparatus according to claim 15, wherein
the message generating part generates the synthesized message by extracting a part of the additional data on the basis of the display time.

17. The message editing apparatus according to claim 15, wherein
the message generating part generates the synthesized message containing metadata in which time information showing timings for displaying each of the plurality of divided text portions is described.

18. The message editing apparatus according to claim 15, wherein
the message generating part generates display condition information showing a condition that the synthesized message can be displayed, and
the transmitting part transmits the display condition information to the destination.

19. The message editing apparatus according to claim 15, wherein
the storage part stores a plurality of keywords, and
the message editing apparatus further comprises:
an extracting part configured to extract the keywords from the text data; and
a selecting part configured to select the additional data corresponding to the keywords extracted by the extracting part.

20. The message communication system comprising:
a first message communication terminal configured to transmit text data;
a second message communication terminal configured to receive the text data; and
a message editing apparatus configured to transmit and receive a message containing the text data between the first message communication terminal and the second message communication terminal,
wherein
the first message communication terminal includes:
an inputting part configured to receive an input of the text data,
a selecting part configured to receive a selection of additional data to be transmitted with the text data,
a display time determining part configured to determine a display time of the text data and the additional data, and
a data transmitting part configured to transmit the text data, the additional data, and the display time to the message editing apparatus, and
the message editing apparatus includes:
a receiving part configured to receive the text data, the additional data, and the display time from the first message communication terminal connected through a communication line,
a storage part configured to store the text data and the additional data,
a dividing part configured to divide the text data into a plurality of divided text portions according to the display time,
a message generating part configured to generate a synthesized message containing the additional data and the plurality of divided text portions selected by the selecting part, and
a transmitting part configured to transmit the synthesized message to a destination specified by the first message communication terminal, and
the second message communication terminal includes:
a message receiving part configured to receive the synthesized message, and
a displaying part configured to display the additional data and sequentially display the plurality of divided text portions during the display time.
